(19) United States
(12) Patent Application Publication
(10) Pub. No.: US 2025/0130703 A1
(43) Pub. Date: Apr. 24, 2025

(54) DEVICE AND METHOD FOR PROVIDING 3D VEHICLE CONTENTS

(71) Applicant: HYUNDAI AUTOEVER CORP., Seoul (KR)

(72) Inventors: Sang Min Seo, Seoul (KR); Young Hwan Lim, Seoul (KR); Tae Joon Park, Seoul (KR); Byeung Soo Kang, Seoul (KR); Jung Won Yu, Seoul (KR)

(73) Assignee: HYUNDAI AUTOEVER CORP., Seoul (KR)

(21) Appl. No.: 18/919,021

(22) Filed: Oct. 17, 2024

(30) Foreign Application Priority Data
Oct. 18, 2023 (KR) 10-2023-0139558

(51) Int. Cl. G06F 3/04845

(52) U.S. Cl. CPC G06F 3/04845

(57) ABSTRACT

A method for providing 3-dimensional (3D) vehicle contents includes importing 3D vehicle data. The method also includes acquiring bill of materials (BOM) data based on options for a vehicle to be displayed. The method further includes searching for part numbers, included in the BOM data, in the 3D vehicle data to activate relevant parts. The method also includes exporting the activated relevant parts in the 3D vehicle data as 3D vehicle content data. The method additionally includes displaying 3D vehicle contents on a user screen.

### CROSS REFERENCE TO RELATED APPLICATION

This application claims the benefit of and priority to Korea Patent Application No. 10-2023-0139558, filed on Oct. 18, 2023, the entire disclosure of which is hereby incorporated herein by reference in its entirety.

### FIELD OF TECHNOLOGY

The present disclosure relates to a technology for providing 3D vehicle contents.

### BACKGROUND

When visiting official web sites of automobile manufacturers, users can experience programs or web platforms by which the users can see appearances of vehicles while changing various options by manipulating 3-dimensional (3D) models of vehicles. Such a program or a web platform provides such functions using a vehicle configurator.

A vehicle configurator is a digital tool that allows buyers or fans of automobiles to select various options for specific automobile models and to look at visualized results in real time. Such tools are provided on official web sites or applications of automobile manufacturers.

Users may select colors, wheels, interior decorations, engines, exteriors, and other options of specific automobiles. Then, vehicle configurators change and display the exterior appearances or interior looks in real time according to the selected options. The vehicle configurators display vehicles using 3D models and users can see the vehicles at various angles by rotating around the vehicles or zooming in/out on the vehicles. Some vehicle configurators allow users to experience vehicles in actual environments or virtual spaces using an augmented reality (AR) function or a virtual reality (VR) function.

When a new automobile model is developed, the relevant automobile manufacturer develops a vehicle configurator for this new automobile model. However, such a model may differ depending on countries and platform engineering (PE). Such a model may also differ depending on model years (MY). Since automobile manufacturers newly develop vehicle configurators whenever new models are produced, it also takes considerable costs and efforts to develop vehicle configurators.

The discussions in this section are intended merely to provide background information and do not constitute an admission of prior art.

### SUMMARY

In an aspect, embodiments of the present disclosure provide a technology for easily producing 3-dimensional (3D) vehicle contents. In another aspect, the embodiments of present disclosure provide a technology that allows for the reuse of duplicated parts in 3D vehicle contents. In another aspect, embodiments of the present disclosure provide a technology that facilitates the history management of 3D vehicle contents and allows managing data as an asset.

According to an embodiment of the present disclosure, a method for providing 3-dimensional (3D) vehicle contents is provided. The method includes importing 3D vehicle data. The method also includes acquiring bill of materials (BOM) data based on options for a vehicle to be displayed. The method additionally includes searching for part numbers, included in the BOM data, in the 3D vehicle data to activate the relevant parts. The method further includes exporting the activated parts in the 3D vehicle data as 3D vehicle content data. The method also includes displaying 3D vehicle contents on a user screen.

The method may further comprise simplifying the depth of each node included in the 3D vehicle data to a predetermined extent.

The method may further comprise sorting the part numbers included in the 3D vehicle data to be in alignment with simplified depth levels of the respective nodes before searching for the part numbers, included in the BOM data, in the 3D vehicle data and activating the relevant parts.

In an embodiment, Quick Sort may be used as a sorting method and binary searches may be used as a searching method.

The method may further comprise mapping one or more of the activated parts in the 3D vehicle data with color data according to colored parts data.

The method may further comprise changing colors of the one or more parts in the 3D vehicle contents according to a user's selection signal.

In an embodiment, the 3D vehicle content data is formed of vector-based 3D data.

In an embodiment, the 3D vehicle content data may be assetized by options and stored, and derived 3D vehicle content data, derived from basic 3D vehicle content data, may be linked to the basic 3D vehicle content data as a branch.

In an embodiment, when the basic 3D vehicle content data is modified, data linked thereto may be updated together.

In an embodiment, the 3D vehicle content data may be transferred to a user device using a web protocol.

According to another embodiment of the present disclosure, a device for providing 3-dimensional (3D) vehicle contents is provided. The device includes a 3D vehicle data processing circuit configured to import 3D vehicle data. The device also includes a combination data generating circuit configured to acquire bill of materials (BOM) data based on options of a vehicle to be displayed. The device additionally includes a combination data mapping circuit configured to search for part numbers, included in the BOM data, in the 3D vehicle data and activate the relevant parts. The device further includes a 3D vehicle appearance output circuit configured to export the activated parts in the 3D vehicle data as 3D vehicle content data.

The 3D vehicle data processing circuit may be configured to simplify the depth of each node included in the 3D vehicle data to a predetermined extent.

The combination data generating circuit may be configured to generate combination data using the BOM data and colored parts data.

The combination data mapping circuit may be configured to activate in the 3D vehicle data parts to be displayed to a user according to the combination data and map some of the activated parts with color data.

The combination data generating circuit may be configured to sort the part numbers included in the 3D vehicle data to be in alignment with simplified depth levels of the respective nodes.

The combination data mapping circuit may be configured to search for each part number by binary searches in the 3D vehicle data sorted by Quick Sort.

The 3D vehicle content data may be formed of vector-based 3D data.

The 3D vehicle content data may be transferred to a user device using a web protocol.

As described above, according to embodiments of the present disclosure, 3D vehicle contents may easily be generated, duplicated parts regarding 3D vehicle contents may be reused, 3D vehicle contents histories may easily be managed, and data may be managed as assets.

### BRIEF DESCRIPTION OF THE DRAWINGS

In order that the disclosure may be well understood, there are now described various forms thereof, given by way of example, reference being made to the accompanying drawings, in which:

FIG. 1 is a configuration diagram of a system to provide 3D vehicle contents according to an embodiment;

FIG. 2 is a configuration diagram of a device for providing contents according to an embodiment;

FIG. 3 is a diagram illustrating a process in which a content providing device according to an embodiment simplifies the depth of each node;

FIG. 4 is a diagram illustrating a process in which a content providing device according to an embodiment generates combination data using bill of materials (BOM) data and colored parts data;

FIG. 5 is a diagram showing as an example that a content providing device according to an embodiment performs Quick Sort;

FIG. 6 is a diagram showing as an example that a content providing device according to an embodiment performs binary searches;

FIG. 7 is a diagram showing that 3D vehicle content data according to an embodiment is assetized and stored; and

FIG. 8 is a flow diagram of a method in which a device according to an embodiment provides 3D vehicle contents.

### DETAILED DESCRIPTION

Hereinafter, some embodiments of the present disclosure are described in detail with reference to the accompanying drawings. With regard to the reference numerals of the components of the respective drawings, it should be noted that the same reference numerals are assigned to the same components even when the components are shown in different drawings. In addition, in describing the present disclosure, detailed descriptions of well-known configurations or functions have been omitted in order to not obscure the gist of the present disclosure.

In addition, terms such as “1st”, “2nd”, “A”, “B”, “(a)”, “(b)”, or the like may be used in describing the components of the present disclosure. These terms are intended only for distinguishing a corresponding component from other components, and the nature, order, or sequence of the corresponding component is not limited to the terms. In the case where a component is described as being “coupled”, “combined”, or “connected” to another component, it should be understood that the corresponding component may be directly coupled or connected to another component or that the corresponding component may also be “coupled”, “combined”, or “connected” to the component via another component provided therebetween.

The terms such as “device,” “circuit,” “module,” and the like refer to one or more units for processing at least one function or operation, which may be implemented by hardware, software, or a combination thereof.

When a component, device, module, element, or the like of the present disclosure is described as having a purpose or performing an operation, function, or the like, the component, device, or element should be considered herein as being “configured to” meet that purpose or perform that operation or function.

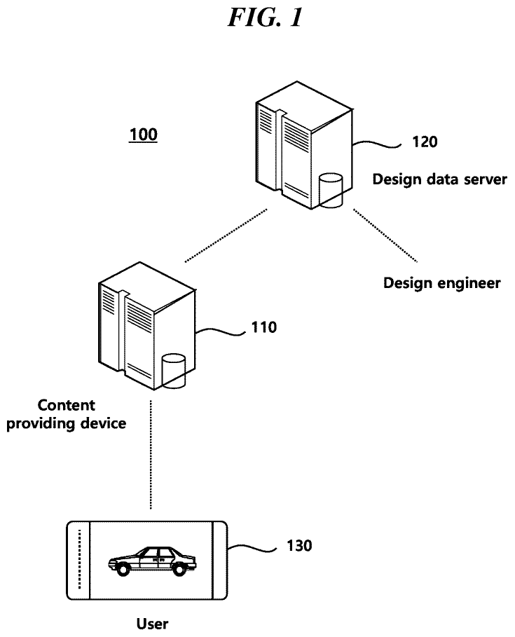

FIG. 1 is a configuration diagram of a system to provide 3D vehicle contents according to an embodiment.

Referring to FIG. 1, a system 100 may comprise a content providing device 110, a design data server 120, and a user device 130.

The user device 130 may be a communication device including a display device.

The user device 130 may be a personal computing device in which an application program, such as a web browser, is embedded. The user device 130 may display data transmitted from the content providing device 110 on a display screen using a web browser function.

The user device 130 may include a user operation recognition device, such as a keyboard, mouse, touch pad, or the like, that recognizes operations of a user. The user device 130 may generate user operation data using the user operation recognition device and may transmit the user operation data to the content providing device 110. The content providing device 110 may change data to be displayed according to the user operation data and may transmit the data to the user device 130.

The user device 130 may display 3D vehicle contents on the display screen. For example, the user may want to verify an appearance and/or vehicle interior of a specific automobile model in 3D using the user device 130. Accordingly, the user device 130 may request 3D vehicle content data from the content providing device 110 and display 3D vehicle content data received from the content providing device 110 on the display screen.

The user may want to see 3D vehicle contents while changing options, colors, etc. of an automobile. The user may operate the user operation recognition device disposed in the user device 130. The user device 130 may recognize user operations, generate user operation data, and transmit the data to the content providing device 110. The content providing device 110 may change 3D vehicle content data according to the user operation data and transmit the data to the user device 130. The user device 130 may display 3D vehicle contents on the display screen based on the changed 3D vehicle content data.

The content providing device 110 may generate 3D vehicle content data and may transmit the data to the user device 130.

The content providing device 110 and the user device 130 may be connected with each other in a server-client manner. The user device 130, as a client, may transmit request data to a server, and the content providing device 110, as a server, may transmit 3D vehicle content data as response data to the request data.

The content providing device 110 may include a web server. The web server may communicate with a client using a protocol called HyperText Transfer Protocol (HTTP). When a client, such as a web browser, requests information or resources from a web server, the web server may provide the information or resources. The web server included the content providing device 110 may wait for a connection request at a specific IP address and port (generally, port 80 in the case of HTTP and port 443 in the case of HTTPS). When a web browser of the user device 130 or another client accesses the web server and requests information from the web server, the web server may receive such a request. Such a request may be processed differently depending on HTTP request methods (GET, POST, PUT, DELETE, etc.). The web server may analyze the request and may conduct a necessary operation. For example, when receiving a request for a static web page, the web server searches for a corresponding file and returns the file. Otherwise, when receiving a request for a dynamic web page, the web server may generate contents using appropriate scripts or database and return the contents. The web server may transmit processed results or requested resources to a client as an HTTP response. The response may also include an HTTP status code (for example: 200 OK, 404 Not Found, etc.), header information, etc. in addition to requested data. The content providing device 110 may transmit 3D vehicle content data to the user device 130 using such a web server.

The content providing device 110 may generate 3D vehicle content data by importing 3D vehicle data stored in the design data server 120.

The 3D vehicle data may be data in which pieces of 3D design data for respective parts forming a vehicle are combined.

The 3D vehicle data may be digital data utilized in various processes, such as the design, manufacture, simulation, testing, etc. of a vehicle. Such 3D vehicle data may include detailed representations of each part and the entire structure of a vehicle and be used for simulating or analyzing shapes, functions, and operations of a vehicle in a computer environment.

The 3D vehicle data may include detailed representations of the interior structure, disposition of parts, coupling methods, etc. of a vehicle as well as its exterior shape. Such data may be utilized for various tests such as impact simulations, aerodynamic simulations, fuel efficiency simulations, etc. Recently, a concept called ‘digital twin’ has emerged, which refers to a digital reproduction of a physical object. When generating a digital twin of a vehicle using 3D vehicle data, the digital twin may be used for monitoring and predicting performance and operations of an actual vehicle in real time. 3D vehicle data may be generated, edited, and managed using various computer-aided design (CAD) tools and software. Such tools secure the standardization and compatibility of data so that numerous suppliers and partners may smoothly exchange information.

When design engineers generate such 3D vehicle data and store it in the design data server 120, the content providing device 110 may generate 3D vehicle content data using the 3D vehicle data.

The 3D vehicle data and the 3D vehicle content data may differ from each other in various aspects. The 3D vehicle data is mainly utilized for the engineering and manufacturing process, such as the design, manufacture, simulation, testing, etc. of vehicles, whereas the 3D vehicle content data may be utilized for users' selections of outer appearances, options, colors of vehicles and visualizations of them. The 3D vehicle content data may mainly be used for the purpose of marketing, sales, enhancement of consumer experiences.

Since their uses are different, the 3D vehicle data and the 3D vehicle content data may have big difference in detailedness of information. The 3D vehicle data may include very detailed information, such as inner structures, dispositions of parts, coupling methods, material characteristics, etc. as well as outer appearances, of vehicles, whereas the 3D vehicle content data may exclude complex details, such as inner structures or information of detailed parts, because it aims to show outer appearances and main options of vehicles to users.

Because of such a difference, the 3D vehicle data may have a big size and require high-performance graphics processing units or specialized software. On the contrary, the 3D vehicle content data may be optimized in its size for real time rendering on a web site or a mobile application or for a minimized loading time. The 3D vehicle content data may be data with a relatively small size and optimized for being smoothly processed in general devices as well.

The content providing device 110 may convert 3D vehicle data stored in the design data server 120 to be suitable for 3D vehicle content data characteristics.

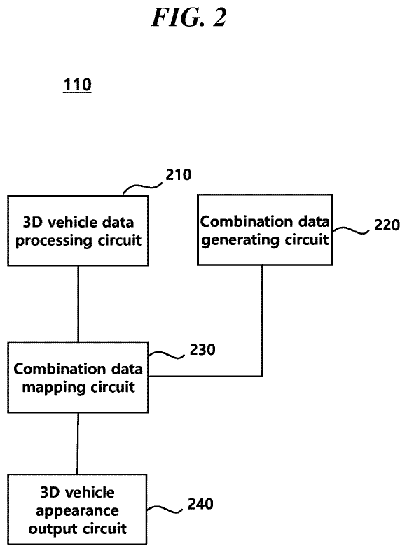

FIG. 2 is a configuration diagram of a device for providing contents according to an embodiment.

Referring to FIG. 2, the content providing device 110 may include a 3D vehicle data processing circuit 210, a combination data generating circuit 220, a combination data mapping circuit 230, and a 3D vehicle appearance output circuit 240.

The 3D vehicle data processing circuit 210 may import 3D vehicle data and may preprocess the 3D vehicle data.

The 3D vehicle data processing circuit 210 may include a graphics engine program that can recognize the 3D vehicle data. The graphics engine program may be, for example, a 3D-MAX program. The 3D vehicle data processing circuit 210 may recognize the 3D vehicle data and preprocess the 3D vehicle data using such programs.

The 3D vehicle data processing circuit 210 may simplify the depth of each node included in the 3D vehicle data to a predetermined extent.

The 3D vehicle data may have a very complicated structure. Since a vehicle comprises hundreds of or thousands of parts, the structure of a 3D model representing these parts may also be complicated. If using the concept of “node”, each part or component may be represented by an individual node and structures of their connections may have complicated depths. Nodes may refer to individual objects or parts in a 3D model. For example, respective parts, such as tires, seats, a handle, an engine of a vehicle, may be represented by nodes. A depth may refer to a hierarchical distance from the top node to a specific node in a connection structure or a hierarchical structure between nodes. For example, when supposing an entire structure of a vehicle as the top node, a hierarchical distance to a specific part inside an engine may be a depth.

Due to the structure and complexity of 3D vehicle data, the 3D vehicle data generally comprises numerous nodes and connection structures between respective nodes may have complicated depths. Such complicated depths may cause increase of a time for searching parts. The 3D vehicle data processing circuit 210 according to an embodiment may simplify the depth of each node included in 3D vehicle data to a predetermined extent as a data preprocessing in order to support a smooth mapping of combination data. The predetermined extent may be a depth of 1-3 steps, for example.

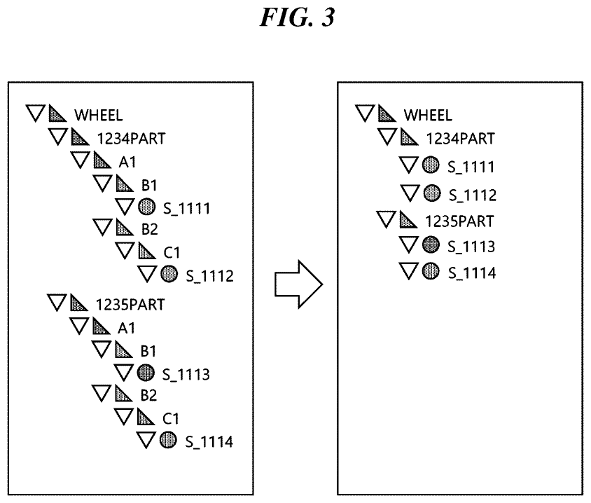

FIG. 3 is a diagram illustrating a process in which a content providing device according to an embodiment simplifies the depth of each node.

Referring to FIG. 3, the content providing device may simplify depths of nodes in the 3D vehicle data.

The rectangle on the left side of FIG. 3 shows nodes of the 3D vehicle data before they are simplified in their depths. The rectangle on the right side of FIG. 3 shows nodes of the 3D vehicle data after they have been simplified in their depths.

Referring to the rectangle on the left side of FIG. 3, the top node represents a category or a part indicated by ‘WHEEL’. Under the ‘WHEEL’ node, there are two nodes representing two sub-parts or sets indicated by ‘1234PART’ and ‘1235PART’. Under these ‘PART’ nodes, there are nodes representing more specific sub-parts indicated by ‘A1’, ‘B1’, ‘B2’, and ‘Cl’, and under these nodes, there are nodes representing detailed items indicated by ‘S_1111’, ‘S_1112’, ‘S_1113’, and ‘S_1114’.

Referring to the rectangle on the right side of FIG. 3, the node ‘WHEEL’ is still on the top and the nodes ‘1234PART’ and ‘1235PART’ are also maintained. However, the nodes for the sub-parts ‘A1’, ‘B1’, ‘B2’, and ‘Cl’ in the middle level are omitted and the nodes for the detailed items ‘S_1111’, ‘S_1112’, ‘S_1113’, and ‘S_1114’ are directly connected right under the nodes for ‘PART’.

As such, the content providing device may simplify hierarchical structures between the nodes to reduce the total depth. In this way, the content providing device may make data have a simpler structure to speed up data searches or operations.

Referring to FIG. 2 again, the content providing device 110 may include the combination data generating circuit 220.

The combination data generating circuit 220 may acquire Bill of Materials (BOM) data based on options of a vehicle to be displayed.

BOM data is very important for vehicle manufactures. A vehicle may be composed of thousands of parts and the BOM data may comprise various information, such as standards, materials, information of suppliers, required amounts, etc. of parts. The BOM data may cover the entire process from sub-assemblies to the final assembly of a vehicle. For example, the engine, transmission, brake system, electric system, body panel, etc. may be superior categories for vehicle BOM data, and under each of these categories, more specific parts and their information may be listed.

In the case of a vehicle, depending on selected options, required parts or materials may differ. For example, a navigation system, leather sheets, a sunroof, a high-performance engine, etc. may be optional items. When a costumer chooses a specific option, parts and materials required for that option may be added to BOM data or an existing part may be replaced with another one.

In a case when parts have different colors, the parts may be considered as different parts or as a same part. If these parts are considered as a same part, the combination data generating circuit 220 may acquire information of colors separately.

The combination data generating circuit 220 may generate combination data using the BOM data. The combination data may be data used for combining parts to be displayed to a user in the 3D vehicle data. The combination data may further include color data for specific parts. Such color data for specific parts may be referred to as colored parts data.

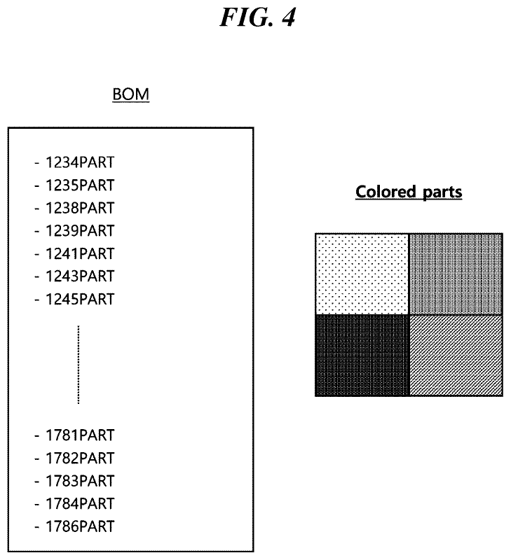

FIG. 4 is a diagram illustrating a process in which a content providing device according to an embodiment generates combination data using BOM data and colored parts data.

Referring to FIG. 4, the content providing device may verify part numbers included in the BOM data. Further, the content providing device may verify color data of parts having colors in the colored parts data. The content providing device may also generate combination data using the BOM data and the colored parts data.

Referring to FIG. 2 again, the content providing device 110 may include the combination data mapping circuit 230 and the 3D vehicle appearance output circuit 240.

The combination data mapping circuit 230 may search for part numbers included in the BOM data in the 3D vehicle data and activate the relevant parts. The 3D vehicle appearance output circuit 240 may export the activated parts in the 3D vehicle data as 3D vehicle content data.

For a smooth mapping of combination data, the combination data generating circuit 220 may sort the part numbers included in the 3D vehicle data to be in alignment with simplified depth levels of respective nodes.

For example, the combination data generating circuit 220 may use Quick Sort as a sorting method. The combination data mapping circuit 230 may search for each part number by binary searches in the 3D vehicle data sorted by Quick Sort.

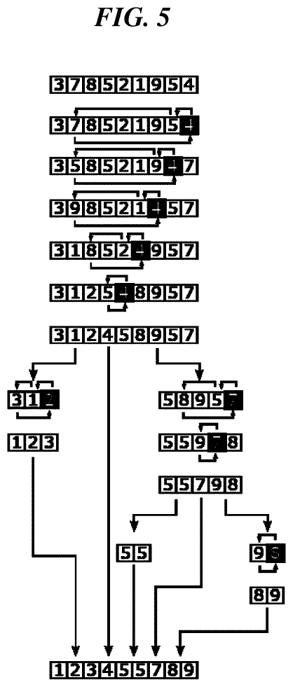

FIG. 5 is a diagram showing as an example that a content providing device according to an embodiment performs Quick Sort.

FIG. 5 visualizes a series of processes of Quick Sort algorithm. Quick Sort is an efficient algorithm that sorts arrays using the divide and conquer strategy.

The content providing device may perform Quick Sort with respect to part numbers of respective nodes included in the 3D vehicle data.

The content providing device may select a pivot. The content providing device may randomly select a pivot among the nodes, or it may select the last part number as a pivot as shown in FIG. 5.

The content providing device may split the part numbers into two parts on the basis of the pivot. The content providing device may dispose part numbers less than the part number of the pivot in one side and dispose part numbers greater than that of the pivot in the other side. In FIG. 5, the part number of the pivot is 4, and the part numbers less than 4 are disposed in the left side and the part numbers greater than 4 are disposed in the right side.

The content providing device may recursively re-sort the part numbers in the two split parts in the same way. FIG. 5 shows that such a process repeats over multiple steps. In each side, a pivot is selected, a split is made, and Quick Sort is performed with respect to the split parts.

The content providing device may end the sort in the relevant side when the number of nodes included in each side becomes 1 or less.

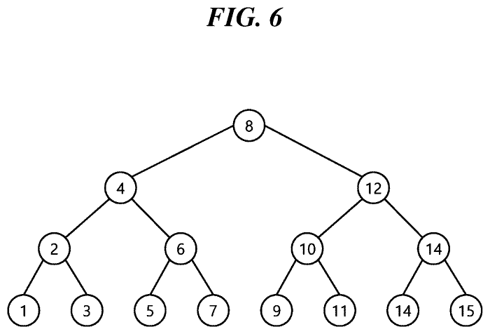

FIG. 6 is a diagram showing as an example that a content providing device according to an embodiment performs binary searches.

The content providing device may search for part numbers, included in the combination data, in the 3D vehicle data sorted by Quick Sort and activate the relevant parts. In an embodiment, the content providing device may search for the part numbers through binary searches.

FIG. 6 shows a binary search tree. The part numbers of the 3D vehicle data, that have been sorted by Quick Sort, may be arranged in a data structure like a binary search tree.

In a binary search tree structure, each node may have one part number, wherein nodes are nodes in a binary search tree structure and may be different from the nodes mentioned in the 3D vehicle data. In one side (the left side) sub-trees, part numbers less than a part number of a parent node may be placed and, in the other side (the right side) sub-trees, part numbers greater than the part number of the parent node may be placed. In an embodiment, the one side sub-trees and the other side sub-trees all may satisfy conditions for a binary search tree.

The content providing device may start with a root node (node 8 in FIG. 6). If a part number to be searched is identical to a value of a current node, the search may end at the value of the current node. If a value to be searched is less than a value of a current node, the content providing device may move to a root node of a sub-tree in one side and, if a value to be searched is greater than a value of a current node, the content providing device may move to a root node of a sub-tree in the other side and repeat the aforementioned process.

Such a binary search may have a time complexity of O (log n) on average.

In an embodiment, 3D vehicle content data may be assetized by options and stored, and derived 3D vehicle content data, derived from basic 3D vehicle content data, may be linked to the basic 3D vehicle content data as a branch.

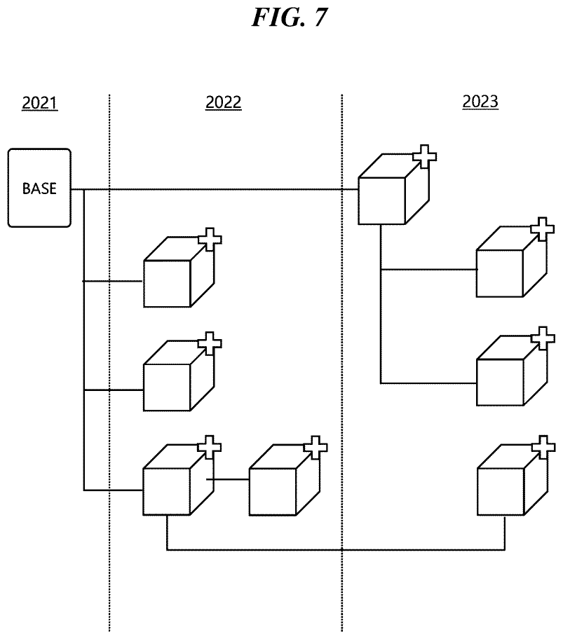

FIG. 7 is a diagram showing that 3D vehicle content data according to an embodiment is assetized and stored.

Referring to FIG. 7, 3D vehicle content data may be assetized by options and stored, and derived 3D vehicle content data, derived from basic 3D vehicle content data, may be linked to the basic 3D vehicle content data as a branch. When the basic 3D vehicle content data is modified, data linked thereto may be updated together.

A quadrangle labelled ‘BASE’ in the left side of the figure indicates the basic 3D vehicle content data. The basic 3D vehicle data may be a reference point for other derived data.

Multiple 3D blocks branched from the basic 3D vehicle content data indicate derived 3D vehicle content data. The 3D vehicle content data may be data reflecting certain changes, modifications, additional items based on the basic 3D vehicle content data.

In the figure, lines represent that derived 3D vehicle content data are directly linked to the basic 3D vehicle content data. Such a structure allows clear understanding about what changes are made in a certain version of data and how those changes are connected with basic data.

Year numbers (2021, 2022, 2023) in the upper side of the figure indicate when each 3D vehicle content data is generated or modified. This allows understanding histories of how 3D vehicle content data is changed and developed over time.

3D vehicle content data may be generated in a Filmbox (FBX) data format. This may have a relatively large size.

The content providing device may convert FBX format data into Universal Scene Description (USD) format data.

USD is a 3D scene graph and data format developed by Pixar Animation Studios. This format was designed for the purpose of efficiently describing large-scaled complex 3D scenes and exchanging scene data among multiple programs and platforms.

When converting FBX format data into USD format data, the size of data may be reduced by about 60%.

Since FBX format data includes all mesh forms of objects, whereas USD format data is vector-based data forming 3D graphics, USD format data may have a relatively small size.

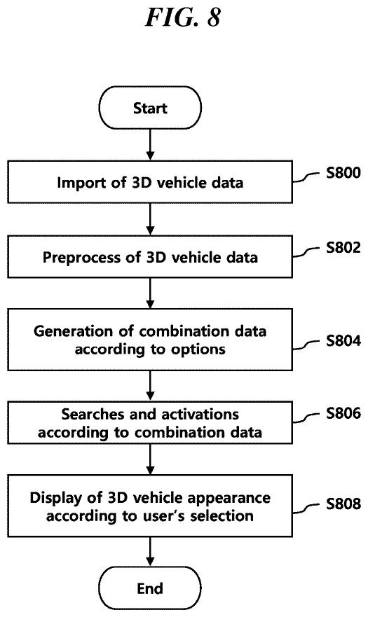

FIG. 8 is a flow diagram of a method in which a device according to an embodiment provides 3D vehicle contents.

Referring to FIG. 8, in an operation S800, the device may import 3D vehicle data.

In an operation S802, the device may simplify the depth of each node included the 3D vehicle data to a predetermined extent. For example, the device may simplify the depth of each node in the 3D vehicle data to two levels.

Subsequently, the device may sort part numbers included in the 3D vehicle data in conformity with a simplified depth level of each node. For example, the device may sort the part numbers included in the 3D vehicle data by Quick Sort.

The device may acquire BOM data according to options of a vehicle to be displayed. In an operation S804, the device may generate combination data using the BOM data and colored parts data.

In an operation S806, the device may search for part numbers, included in the BOM data, in 3D vehicle data and activate the relevant parts. The device may search for the part numbers, included in the BOM data, in the 3D vehicle data using binary searches.

In addition, the device may map some of the activated parts in the 3D vehicle data with color data according to the colored parts data.

Then, the device may change colors of some parts in 3D vehicle contents according to a user selection signal.

The 3D vehicle content data may be formed of vector-based 3D data.

The 3D vehicle content data may be assetized by options and stored, and derived 3D vehicle content data, derived from basic 3D vehicle content data, may be linked to the basic 3D vehicle content data as a branch. When the basic 3D vehicle content data is modified, data linked thereto may be updated together.

In an operation S808, the device may export the activated parts in the 3D vehicle data as 3D vehicle content data and display 3D vehicle contents on a user screen.

As described above, according to embodiments of the present disclosure, 3D vehicle contents may easily be generated, duplicated parts regarding 3D vehicle contents may be reused, 3D vehicle contents histories may easily be managed, and data may be managed as assets.

Since terms, such as “including,” “comprising,” and “having” mean that corresponding elements may exist unless they are specifically described to the contrary, it should be construed that other elements can be additionally included, rather than that such elements are excluded. All technical, scientific, or other terms are used consistently with the meanings as understood by a person skilled in the art unless defined to the contrary. Common terms as found in dictionaries should be interpreted in the context of the related technical writings, rather than overly ideally or impractically, unless the present disclosure expressly defines them so.

Although example embodiments of the present disclosure have been described for illustrative purposes, those having ordinary skill in the art should appreciate that various modifications, additions, and substitutions are possible without departing from the scope and spirit of the present disclosure. Therefore, the embodiments described in the present disclosure are intended to illustrate the scope of the technical idea of the present disclosure, and the scope of the present disclosure is not limited by the described embodiments. The scope of the present disclosure should be construed on the basis of the accompanying claims in such a manner that all of the technical ideas included within the scope equivalent to the claims are included in the present disclosure.

What is claimed is:

1. A method for providing 3D vehicle contents comprising:
importing 3-dimensional (3D) vehicle data;
acquiring bill of materials (BOM) data based on options for a vehicle to be displayed;
searching for part numbers, included in the BOM data, in the 3D vehicle data to activate relevant parts;
exporting the activated relevant parts in the 3D vehicle data as 3D vehicle content data; and
displaying 3D vehicle contents on a user screen.

2. The method of claim 1, further comprising simplifying depth of each node included in the 3D vehicle data to a predetermined extent.

3. The method of claim 2, further comprising sorting part numbers included in the 3D vehicle data to be in alignment with simplified depth levels of respective nodes before searching for the part numbers, included in the BOM data, in the 3D vehicle data and activating the relevant parts.

4. The method of claim 3, wherein:
sorting the part numbers included in the 3D vehicle data includes sorting the part numbers using Quick Sort; and
searching for the part numbers in the 3D vehicle data includes searching for the part numbers using binary searches.

5. The method of claim 1, further comprising mapping one or more of the activated relevant parts in the 3D vehicle data with color data according to colored parts data.

6. The method of claim 5, further comprising changing colors of the one or more of the activated relevant parts in the 3D vehicle contents according to a selection signal indicating a selection of a user.

7. The method of claim 1, wherein the 3D vehicle content data is formed of vector-based 3D data.

8. The method of claim 1, wherein the 3D vehicle content data is assetized by options and stored, and wherein derived 3D vehicle content data, derived from basic 3D vehicle content data, is linked to the basic 3D vehicle content data as a branch.

9. The method of claim 8, wherein, when the basic 3D vehicle content data is modified, data linked to the basic 3D vehicle content data is updated.

10. The method of claim 1, wherein the 3D vehicle content data is transferred to a user device using a web protocol.

11. A device for providing 3-dimensional (3D) vehicle contents comprising:
a 3D vehicle data processing circuit configured to import 3D vehicle data;
a combination data generating circuit configured to acquire bill of materials (BOM) data based on options of a vehicle to be displayed;
a combination data mapping circuit configured to search for part numbers, included in the BOM data, in the 3D vehicle data and activate relevant parts; and
a 3D vehicle appearance output circuit configured to export the activated relevant parts in the 3D vehicle data as 3D vehicle content data.

12. The device of claim 11, wherein the 3D vehicle data processing circuit is configured to simplify depth of each node included in the 3D vehicle data to a predetermined extent.

13. The device of claim 11, wherein the combination data generating circuit is configured to generate combination data using the BOM data and colored parts data.

14. The device of claim 13, wherein the combination data mapping circuit is configured to:
activate, in the 3D vehicle data, the relevant parts to be displayed to a user according to the combination data; and
map one or more of the activated relevant parts with color data.

15. The device of claim 11, wherein the combination data generating circuit is configured to sort part numbers included in the 3D vehicle data to be in alignment with simplified depth levels of respective nodes.

16. The device of claim 15, wherein the combination data mapping circuit is configured to:
sort the part numbers included in the 3D vehicle data using Quick Sort; and
search for the part numbers using binary searches in the 3D vehicle data sorted using Quick Sort.

17. The device of claim 11, wherein the 3D vehicle content data is formed of vector-based 3D data.

18. The device of claim 11, wherein the 3D vehicle content data is transferred to a user device using a web protocol.

19. The device of claim 11, wherein the 3D vehicle content data is assetized by options and stored, and wherein derived 3D vehicle content data, derived from basic 3D vehicle content data, is linked to the basic 3D vehicle content data as a branch.

20. The device of claim 19, wherein, when the basic 3D vehicle content data is modified, data linked to the basic 3D vehicle content data is updated.
